(19) United States
(12) Patent Application Publication
(10) Pub. No.: US 2010/0297901 A1
(43) Pub. Date: Nov. 25, 2010

(54) COLORING COMPOSITION FOR PREVENTING SEE-THROUGH OF CLOTH, COLORING METHOD USING THE COLORING COMPOSITION AND CLOTH WHOSE BACK IS COLORED

(75) Inventors: Takayuki Ikai, Yokohama-shi (JP); Shigeru Miyazaki, Yokohama-shi (JP); Tadashi Kamagata, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI PENCIL COMPANY, LIMITED, Shinagawa-ku, Tokyo (JP)

(21) Appl. No.: 12/445,877

(22) PCT Filed: Oct. 25, 2007
(86) PCT No.: PCT/JP2007/070836

§ 371 Date: Apr. 16, 2009

(30) Foreign Application Priority Data
Oct. 25, 2006 (JP) 2006-289455

(51) Int. Cl. B32B 27/04; C08L 33/06; C08L 75/04; C08L 67/00

(52) U.S. Cl. 442/59; 524/560; 524/591; 524/599

(57) ABSTRACT

The present invention relates to a coloring composition for preventing see-through of cloth which comprises, on the basis of the total mass of the composition, a pigment in an amount ranging from 0.002% by mass to 1% by mass; a polymer particulate dispersion; and water.

The present invention can thus provide the cloth which can prevent any see-through of the color of the underlying layer without causing any color-see-through phenomenon even if the cloth is white or light-colored one, and which can show excellent fastness while maintaining hand and feel peculiar to the original cloth irrespective of the material of the cloth used. In addition, even the mixed spun cloth can be colored with only the coloring composition of the present invention according to the single-step coloring technique and the coloring method according to the present invention is quite simple and excellent in working efficiency, energy efficiency and water resource-efficiency and the method does not suffer from a problem of, for instance, any environmental pollution.

### TECHNICAL FIELD

The present invention relates to an optimum coloring composition for pigmenting the back of cloth in order to impart, to the cloth, a see-through-preventing function, a coloring method which makes use of the coloring composition and cloth whose back gets colored with the coloring composition. More specifically, the present invention relates to the see-through prevention of cloth by the coloration of the back of white or light-colored clothes (such as skirts, slacks, white robes or overalls and swimming suits).

### BACKGROUND ART

The white or light-colored cloth has a high light-transmittance. Accordingly, when wearing white or light-colored clothes, the color and the shape of the underwear worn inside the clothes, the color of the skin, the body hair and the like can be seen through the clothes and this is accordingly unfavorable from the viewpoint of fine sight. This problem will become more and more conspicuous, in particular, when the clothes contain moisture such as sweat.

To solve the foregoing problem, there have conventionally been proposed such methods as one in which the thickness of the cloth is increased and one in which another cloth is used as the cloth for lining.

However, these methods suffer from a problem such that the hand and feel of the cloth peculiar thereto are impaired. These methods are not suitable since the characteristic properties of the cloth by nature are greatly reduced, in particular, when the cloth is thin. Moreover, if the cloth is white or light-colored one, the increase of the thickness of the cloth is not satisfied since the effect of preventing the see-through would still be insufficient and the color of the lining cloth would be seen through the white or light-colored cloth.

As a means for eliminating the foregoing drawbacks, there has been proposed a method for preventing the see-through of cloth, which comprises the step of applying a light-absorbing layer of a dye onto the back of the cloth to thus control the transmission of any light ray (see Patent Document 1).

However, this method uses a dye as a coloring material and accordingly, a problem arises such that the dye is dissolved out of the cloth due to the action of the moisture such as sweat and this in turn causes contamination or stain of the skin and/or the underwear.

Moreover, the affinity of a dye for cloth is dominated by the bonding strength (affinity) between the dye and the cloth and therefore, it is essential to select a dye having a good dye-affinity for the material of cloth to be dyed. For this reason, it is difficult to uniformly dye a mixed spun fabric consisting of different kinds of materials. This problem may be solved by a method in which the dyeing step is repeated over several times, but such a method suffers from a problem such that it requires an increased production cost.

Furthermore, the dye is highly permeable to the cloth and therefore, it is quite difficult to dye only the superficial layer of the back of the cloth. The difficulty would become more conspicuous, in particular, when the cloth is thin and/or it is white or light-colored one. Accordingly, there have been adopted, for instance, the dry dye-transfer technique or the wet dye-transfer technique, but it would be desirable to directly color cloth, while taking into consideration the cost-saving through the improvement of the reproducibility of the dyeing process and the simplification thereof.

From the foregoing, the coloring of cloth should be carried out using a pigment. If a pigment is simply applied onto the surface of cloth, however, various problems arise, for instance, the pigment applied onto the surface of the cloth is easily peeled off when the clothes are rubbed with the skin or the body or the underwear and the hand and feel peculiar to the cloth would be reduced or impaired because of the component used for adhering the pigment to the cloth.

### [Patent Document 1] JP-A-Sho55-062283

### DISCLOSURE OF THE INVENTION

### Problems that the Invention is to Solve

It is accordingly an object of the present invention to provide a coloring composition for preventing see-through of cloth, a coloring method which makes use of the coloring composition and cloth whose back is colored with such a coloring composition. More specifically, the object of the present invention is to provide a coloring composition which has a low probability of causing any staining due to the dissolution of a coloring material, which has a high fastness to rubbing, which is hardly accompanied by the reduction of the hand and feel of the original cloth, which can be applied to a variety of materials and which permits the simplification of the dyeing process; a coloring method using the coloring composition and cloth whose back is colored with the composition.

### Means for the Solution of the Problems

The inventors of this invention have conducted various studies to solve the foregoing problems, have found that the problems can be solved by coloring the back of cloth using a combination composed of a pigment and a polymer particulate dispersion and have thus completed the present invention.

Accordingly, the present invention herein provides a coloring composition, a coloring method using the coloring composition and cloth whose back is colored with the same, as will be specified below:

1. A coloring composition for preventing see-through of cloth which is characterized in that it comprises, on the basis of the total mass of the composition, the following components:

a pigment in an amount ranging from 0.002% by mass to 1% by mass;

a polymer particulate dispersion; and

water.

2. The coloring composition for preventing see-through of cloth as set forth in the foregoing item 1, wherein the polymer particulate dispersion comprises at least one component selected from the group consisting of polyurethanes, polyesters and polyacrylics.
3. The coloring composition for preventing see-through of cloth as set forth in the foregoing item 1 or 2, wherein the polymer particulate dispersion has a glass transition temperature of not higher than 20° C.
4. The coloring composition for preventing see-through of cloth as set forth in any one of the foregoing items 1 to 3, wherein the average particle size of the pigment is not greater than 150 nm.
5. The coloring composition for preventing see-through of cloth as set forth in any one of the foregoing items 1 to 4, wherein the pigment is a black pigment.
6. A method of coloring the back of cloth characterized by the use of a coloring composition for preventing see-through of cloth as set forth in any one of the foregoing items 1 to 5.
7. Cloth characterized in that the back of the cloth is colored with at least a pigment and a polymer particulate dispersion and that the brightness of color of the back ranges from 40 to 93 (L*: D65-2°).
8. The cloth as set forth in the foregoing item 7, wherein the polymer particulate dispersion comprises at least one component selected from the group consisting of polyurethanes, polyesters and polyacrylics.
9. The cloth as set forth in the foregoing item 7 or 8, wherein the polymer particulate dispersion has a glass transition temperature of not higher than 20° C.
10. The cloth as set forth in any one of the foregoing items 7 to 9, wherein the average particle size of the pigment is not greater than 150 nm.
11. The cloth as set forth in any one of the foregoing items 7 to 10, wherein the pigment is a black pigment.
12. The cloth as set forth in any one of the foregoing items 7 to 11, wherein the right side of the cloth is white or colored with a light or pale color.
13. Clothes characterized in that they are obtained using cloth as set forth in any one of the foregoing items 7 to 12.

### EFFECTS OF THE INVENTION

The cloth according to the present invention, which is subjected to a process for preventing see-through shows a variety of excellent effects as will be detailed below since a pigment is used as a coloring agent and the pigment is adhered to the cloth using polymer particles:

The cloth can show a satisfactory see-through-preventing effect even if the cloth is white or light-colored one;

The coloring material does not permeate towards the right side of the cloth and accordingly, the color of the back of the cloth is not seen, from the right side (surface), through the cloth (hereunder referred to as “color-see-through phenomenon” or “color-transfer phenomenon”);

The coloring material is not dissolved out of the applied pigment layer due to the presence of moisture, unlike a dye;

The coloring material is not removed from the back of the cloth even when the cloth is rubbed;

The hand and feel peculiar to the cloth are not reduced even after the coloration;

Even the mixed spun cloth can be colored with only the coloring composition of the present invention according to the single-step coloring technique; and

The present invention does not require the use of any transfer step and the coloring process can thus be simplified.

The reasons why the cloth subjected to the see-through-preventing treatment is excellent as compared with the conventional one, as has been discussed above in detail, would be considered to be as follows:

When dyeing the back of cloth using a dye according to the conventional technique, the dye is dissolved in a solvent component for the coloring composition, the dye applied to the back of the cloth is thus liable to cause penetration into the cloth towards the right side thereof and this accordingly results in the occurrence of the color-see-through phenomenon. Thus, the use of a dye is not preferred. This problem would become more and more conspicuous, in particular, when the cloth is white or light-colored one or it is thin. To solve this problem, the permeation of the coloring material into the cloth and towards the right side thereof should be controlled to a level as low as possible and the coloring material should be confined within the superficial layer of the back.

Contrary to this, according to the coloring composition and the coloring method of the present invention, a pigment is used as a coloring material, which is insoluble in a solvent for the coloring composition. Accordingly, the pigment is not entrained by the solvent and the coloring material can easily be confined within the superficial layer on the back of the cloth. Furthermore, a polymer particulate dispersion is incorporated into the coloring composition and the dispersion can serve as a filler for the openings or spaces formed between fibers constituting the cloth. Thus, the coloring material is confined within the superficial layer on the back of the cloth due to such a synergistic effect and the resulting cloth whose back is colored is almost completely free of any such a color-see-through phenomenon even if coloring the white, light-colored or thin cloth.

Moreover, the polymer particles form a film as the solvent component present in the coloring composition is evaporated so that the pigment is thus strongly adhered to the cloth even if the pigment is present in the superficial layer on the back of the cloth. Accordingly, the cloth whose back is colored shows excellent fastness of the color to any rubbing action and improved water-resisting properties.

In addition, the fixation of the pigment by the polymer particles is not affected by the affinity of the pigment for the material of cloth and accordingly, even the mixed spun material can be colored with only a single coloring composition according to the single-step coloring technique, without taking into consideration the affinity of the coloring material for the material to be colored unlike the coloration with a dye.

### BEST MODES FOR CARRYING OUT THE INVENTION

Embodiments according to the present invention will be described in detail below.

The term “cloth” used herein means yarn, a dishcloth or a napkin, textile (or a fabric), a nonwoven fabric, and goods produced using them, which comprise natural fibers, synthetic fibers, semi-synthetic fibers or a mixture thereof.

Moreover, the term “the back of cloth” herein used means, in case of, for instance, clothes, the face of the cloth, which is closer to the body and the term “the right side or surface (of cloth)” herein used means the face of the cloth, which is opposite to the back thereof.

As the pigments used in the coloring composition of the present invention, there may be listed, for instance, all of the inorganic and organic pigments which are dispersible in water and aqueous solvents. In addition, it is also possible to use a pseudo-pigment obtained by coloring resin particles with a dye or a pigment.

Examples of inorganic pigments usable herein include metal powders, and powders of metal-containing compounds; and examples of organic pigments usable herein are azo lake pigments, insoluble azo pigments, chelate azo pigments, phthalocyanine pigments, perylene and perinone pigments, anthraquinone pigments, quinacridone pigments, dye lake pigment, nitro pigments, and nitroso pigments.

More specifically, examples of the pigments usable herein include inorganic pigments such as carbon black (e.g., channel black, furnace black and thermal black), titanium black, iron black, graphite, copper chromium black, cobalt black, red iron oxide, chromium oxide, cobalt blue, yellow iron oxide, viridian, cadmium yellow, vermilion, cadmium red, lead yellow, molybdate orange, zinc chromate, strontium chromate, ultramarine blue, baryte powder, Prussian blue, manganese violet, aluminum powder and brass powder; and organic pigments such as aniline black, perylene black, cyanine black, pseudo-pigment obtained by coloring resin particles with a black dye or pigment, C.I. Pigment Blue 1, C.I. Pigment Blue 15, C.I. Pigment Blue 17, C.I. Pigment Blue 27, C.I. Pigment Red 5, C.I. Pigment Red 22, C.I. Pigment Red 38, C.I. Pigment Red 48, C.I. Pigment Red 49, C.I. Pigment Red 53, C.I. Pigment Red 57, C.I. Pigment Red 104, C.I. Pigment Red 146, C.I. Pigment Red 245, C.I. Pigment Yellow 1, C.I. Pigment Yellow 3, C.I. Pigment Yellow 4, C.I. Pigment Yellow 12, C.I. Pigment Yellow 13, C.I. Pigment Yellow 14, C.I. Pigment Yellow 17, C.I. Pigment Yellow 34, C.I. Pigment Yellow 55, C.I. Pigment Yellow 74, C.I. Pigment Yellow 83, C.I. Pigment Yellow 95, C.I. Pigment Yellow 166, C.I. Pigment Yellow 167, C.I. Pigment Orange 13, C.I. Pigment Orange 16, C.I. Pigment Violet 1, C.I. Pigment Violet 3, C.I. Pigment Violet 19, C.I. Pigment Violet 23, C.I. Pigment Violet 50, and C.I. Pigment Green 7. In the present invention, the foregoing pigments can be used alone or as a mixture containing at least two of them.

The average particle size of the pigment particles present in the coloring composition of the present invention is preferably not greater than 200 nm, further preferably not greater than 150 nm and still further preferably not greater than 100 nm. This is because if the average particle size thereof is not greater than 200 nm, unevenness of the cloth surface after the coloration thereof can be reduced and therefore, the removal of the pigment from the colored cloth due to friction or rubbing can be reduced and fastness of the pigment to rubbing can likewise be increased to a level equal to or higher than a predetermined one. On the other hand, if the composition comprises pigment particles whose average particle size is smaller than 10 nm, there is observed such a tendency that the resulting coloring composition has reduced or impaired characteristic properties such as a reduced color-developing density and light resistance. For this reason, the average particle size of the pigment particles used in the present invention ranges from 200 nm to 10 nm, preferably 150 to 10 nm and more preferably 100 to 20 nm.

The average particle size of the pigment particles used herein can be controlled to a level of not greater than 200 nm according to, for instance, a method which comprises the steps of adding, to the foregoing pigment, water and an aqueous solvent, and optionally a moisturizing agent, a wetting agent, and/or a dispersion-stabilizing agent and then blending these ingredients using a currently used shearing force-applying type dispersion device. For instance, intended pigment particles having a predetermined average particle size can be obtained by treating a coloring composition containing pigment particles for a predetermined time period using a dispersion device such as a stirring-type dissolver, a homomixer, a Henschel mixer, a medium-type ball mill, a sand mill, an attritor, a paint shaker, a medium-less type three-roll or five-roll mill, a jet mill, a water-jet mill and an ultrasonic dispersion device.

Moreover, after the pulverization and dispersion of the pigment particles in a dispersion device, coarse particles and fine particles can, if necessary, be removed from the resulting pulverized pigment particles and this would ensure the preparation of pigment particles having a predetermined and desired average particle size. In this respect, the undesired pigment particles can be removed by a method such as the static or motionless sedimentation technique, the centrifugal sedimentation technique, and the method for the removal through filtration.

The pigment particles used in the present invention are quite fine ones. Therefore, they may undergo re-agglomeration due to certain external factors or during the process for coloring cloth and this would result in the reduction of the desired characteristic properties of the coloring composition. To prevent the occurrence of such re-agglomeration of pigment particles, the surface of the pigment particles is preferably subjected to a hydrophilization treatment, in advance.

Such hydrophilization treatments include, for instance, a method comprising the steps of treating pigment particles with a dispersant containing, for instance, a surfactant or a water-soluble polymer to thus impart, to the surface of the pigment particles, hydrophilic groups such as hydroxyl groups, carboxyl groups and/or amino groups and to thereby improve the dispersion-stability of the pigment particles. Examples of such surfactants usable herein include anionic surfactants such as alkyl carboxylic acid esters, alkyl sulfuric acid esters, and alkyl phosphoric acid esters; cationic surfactants such as aliphatic ammonium salts; and nonionic surfactants such as alkyl ethers, fatty acid esters, and sorbitan fatty acid esters. Moreover, examples of the foregoing water-soluble polymers are polymeric dispersants such as polyvinyl pyrrolidone, polyvinyl alcohols, acrylic acids (for instance, low molecular weight polyacrylic acids and poly(meth)acrylic acids), poly(maleic acids), copolymers of styrene with, for instance, acrylic acid or methacrylic acid, polyamides, and rosin-modified maleic acids.

Alternatively, the surface of the pigment particles can likewise be hydrophilized according to a method such as a treatment with an alkali such as sodium hydroxide, a treatment with an oxidizing agent such as chromic acid, and a topochemical method such as a low-temperature plasma-treatment.

Among the hydrophilic groups which can be added to pigment particles through the hydrophilization treatment, hydroxyl groups and carboxyl groups are especially preferred in the present invention since it would be expected that they may take part in a crosslinking reaction of polymer particles with a crosslinking agent upon coloration of a fibrous structure and that fastness of the pigment may accordingly be improved.

The content of the pigment particles in the coloring composition of the present invention ranges from 0.002 to 1% by mass, preferably 0.004 to 0.5% by mass and more preferably 0.01 to 0.1% by mass on the basis of the total mass of the composition. This is because if the content thereof is less than 0.002% by mass, there is observed such a tendency that the achievement of an intended satisfactory color-see-through-preventing effect cannot be expected at all, while the use of the pigment particles in a content of greater than 1% by mass is not preferred since the color of the back of cloth can be seen through the cloth, from the right side thereof.

The polymer particles used in the present invention are those capable of being dispersed in water and an aqueous solvent. The average particle size thereof is not greater than 500 nm, preferably not greater than 200 nm and more preferably not greater than 100 nm. If the average particle size of the polymer particles exceeds 500 nm, there may be such a tendency that the film layer formed on the cloth becomes bulky and that this in turn leads to reduction of the binding power to thus cause reduction of fastness to rubbing. On the other hand, if the average particle size thereof is less than 10 nm, the polymer particles have a tendency to reduce the effect of anchoring or confining the pigment particles within the region near the surface of the back of the cloth and to reduce a storage stability of the formulated liquid of the coloring composition due to agglomeration of pigment particles. For this reason, the average particle size of the polymer particles used in the present invention ranges from 10 to 500 nm, preferably 10 to 200 nm and further preferably 20 to 100 nm. In particular, if the average particle size of the polymer particles is controlled to a level falling within the range of from 10 to 100 nm, the polymer particles can impart good fastness of the pigment particles to the colored cloth without deteriorating the hand and feel peculiar to the cloth, while suitably confining the pigment particles within the superficial layer of the back of the cloth.

It is desirable that the polymer particles used in the present invention preferably has a glass transition temperature of not higher than 20° C., and more preferably not higher than 10° C. In this respect, if the glass transition temperature of the polymer particles exceeds 20° C., the polymer insufficiently forms a film when the coloring method of the present invention is applied to cloth under working environment maintained at room temperature (20° C.±10° C.), a great deal of voids are formed within a film thus formed, the voids still remain therein even after the heat-treatment of the colored cloth and this accordingly becomes a cause for reduction of the fastness. If the glass transition temperature of the polymer particles is not higher than 20° C., the polymer can be formed into a uniform film at room temperature and can ensure good fastness of the pigment.

The polymer particles used in the present invention are not restricted to particular ones inasmuch as they have the physical properties specified above and examples thereof include commonly available polymers such as acrylic polymers, acrylic acid-styrene copolymers, acrylic acid-urethane copolymers, acrylic-maleic acid copolymers, acrylic acid-butadiene copolymers, acrylic acid-vinyl acetate copolymers, ethylene-vinyl acetate copolymers, polyurethanes, polyolefins and polyesters. Among them, preferably used in the present invention are polymers each comprising, as a main component, at least one member selected from the group consisting of polyacrylic acids, polyurethanes, and polyesters from the viewpoint of the hand and feel of the resulting colored cloth and the fastness of the film formed. More preferably used herein include polymers each comprising, as main component, polyurethanes or polyesters.

The polymer particles used in the present invention may be used in the form of, for instance, an emulsion or a dispersion. A method for preparing such an emulsion or a dispersion is not restricted to any specific one, but a colloidal dispersion which is prepared according to phase-inversion emulsification technique is preferred since this technique permits reduction of an amount of free surfactant molecules remaining in the resulting emulsion and the polymer used is hydrophilic by nature. The use of such polymer particles would permit the formation of a film having a relatively high fastness (or duration).

The content of the polymer particles in the coloring composition according to the present invention preferably ranges from 0.5 to 20% by mass, and more preferably 1 to 10% by mass of the polymer particulate component, on the basis of the total mass of the composition. If the content thereof is less than 0.5% by mass, there may be observed such a tendency that the resulting film do not have any satisfactory duration, while if it exceeds 20% by mass, there may be observed such a tendency that the hand and feel of the resulting colored cloth are deteriorated or damaged.

When coloring cloth in the present invention, a coloring method particularly preferably used is a coloring method through printing.

In this case, it is necessary to adjust the viscosity of the coloring composition to a level such that a transfer-control plate can normally be operated. For instance, when using a silk-screen printing plate, a viscosity of the coloring composition should be controlled to such an extent that the composition does not undergo any leakage through the mesh of the screen.

For instance, when using a silk-screen printing plate having a large mesh size on the order of 60 mesh, filaments usually having a filament diameter of 83 μm are used and the silk-screen has an open area ratio of 65% and a mesh size of 340 μm. For this reason, the coloring composition should have such a viscosity that it does not permeate through the screen even at a permeation volume of 55 cm³/m².

It is thus desirable to adjust a preferred viscosity of the coloring composition used in the foregoing method to a level of not less than 5,000 mPa·s and more preferably not less than 20,000 mPa·s. However, if a viscosity thereof exceeds 200,000 mPa·s, there may be observed such a tendency that the coloring composition causes clogging of the mesh of the screen printing plate since the viscosity of the composition is too high and accordingly, any satisfied coloring operation cannot be carried out. Therefore, a viscosity of the coloring composition when using a silk-screen printing plate having a large mesh size on the order of 60 mesh preferably ranges from 5,000 to 200,000 mPa·s and more preferably 20,000 to 100,000 mPa·s.

When using a silk-screen printing plate having a small mesh size on the order of 120 mesh, currently used are filaments having a filament diameter ranging from 48 to 83 μm and the silk-screen has an open area ratio of 49% and a mesh size of 152 μm. For this reason, the coloring composition should have such a viscosity that it does not permeate through the screen even at a permeation volume of 39 cm³/m² and the composition should have a good ability of passing through the screen mesh when applying a pressure with a squeegee roll. To prevent the penetration of the composition into the cloth, a viscosity of the composition is desirably controlled to a level of not less than 3,000 mPa·s, and preferably not less than 15,000 mPa·s. However, if the viscosity thereof upon the application of a pressure using a squeegee exceeds 150,000 mPa·s, there is observed such a tendency that the mesh of the screen printing plate is clogged with the coloring composition since the viscosity of the composition is too high and accordingly, any satisfactory coloring operation cannot be carried out. Therefore, a viscosity of the coloring composition when using a silk-screen printing plate having a small mesh size on the order of 120 mesh preferably ranges from 3,000 to 150,000 mPa·s and more preferably 15,000 to 80,000 mPa·s.

When using a silk-screen printing plate having a mesh size on the order of 230 mesh for the implementation of the high quality and high precision coloration through printing, currently used are filaments having a filament diameter ranging from 48 to 67 μm and the silk-screen has an open area ratio of 28% and a mesh size of 65 μm. For this reason, the coloring composition should have such a viscosity that it does not permeate through the screen even at a permeation volume of 22 cm³/m² and the composition should have a good ability of passing through the screen mesh when applying a pressure with a squeegee roll. To prevent the penetration of the composition into the cloth, a viscosity of the composition is desirably controlled to a level of not less than 1,000 mPa·s, and preferably not less than 2,000 mPa·s. However, if a viscosity thereof upon the application of a pressure using a squeegee roll exceeds 120,000 mPa·s, there is observed such a tendency that the mesh of the screen printing plate is clogged with the coloring composition since the viscosity of the composition is too high and accordingly, any satisfactory coloring operation cannot be carried out. Therefore, a viscosity of the coloring composition when using a silk-screen printing plate having a smaller mesh size on the order of 230 mesh preferably ranges from 1,000 to 120,000 mPa·s and more preferably 2,000 to 70,000 mPa·s.

As has been discussed above in detail, when coloring cloth using the coloring composition of the present invention according to the printing technique, a viscosity of the coloring composition should appropriately be adjusted while taking into account the mesh number, the mesh size and the value of the permeation volume of the silk-screen printing plate to be used. This would accordingly permit the implementation of high quality and high precision coloration procedures.

The squeegee roll used in the coloration of cloth with the coloring composition of the present invention should be one which can apply a pressure to the coloring composition placed on the silk-screen printing plate, which favorably allows the coloring composition to pass through the interstices of the screen mesh and which can scrape off the unnecessary excess coloring composition, and therefore, the squeegee roll should have a proper elasticity. In this connection, if the squeegee roll has a Shore hardness of not higher than 35 degrees, the squeegee roll suffers from such problems that the strength thereof is insufficient and that it may immediately be worn away, while if it is not less than 91 degrees, the squeegee likewise suffers from such problems that it is insufficient in the elasticity and that it cannot desirably scrape off the excess coloring composition present on the silk screen. Accordingly, the squeegee to be used in the coloring method of the present invention should have a Shore hardness more preferably ranging from 40 to 80 degrees and the squeegee having a hardness falling within the range specified above would have high quality physical properties and be excellent in the durability. Materials for forming the squeegee is not restricted to particular ones inasmuch as they can satisfy the requirements for the physical properties, in particular, Shore hardness. Thus, the materials may be selected from easily available and currently used ones such as elastic molded articles and resins without any restriction. Specific examples thereof usable herein include acrylic rubber, acrylic-urethane rubber, acrylonitrile rubber, acrylic-butadiene rubber (acrylic acid or methacrylic acid-butadiene rubber), urethane rubber, butadiene rubber, butyl rubber, NBR (acrylonitrile-butadiene rubber), epoxy elastomer, and fluororubber.

In addition to the coloring methods illustrated and described above, the coloration of cloth can likewise be carried out according to conventionally known method which makes use of an ink jet printer. In this case, the coloring operation may be carried out using an ink cartridge in which the coloring composition of the present invention is charged. In this respect, to discharge the coloring composition through the ink head of the ink jet printer, a viscosity of the coloring composition should be adjusted to a level of not higher than 50 mPa·s, preferably not higher than 20 mPa·s, and more preferably not higher than 10 mPa·s. In this connection, if a viscosity thereof exceeds 50 mPa·s, there is observed such a tendency that the composition is unstably discharged through the ink head.

The coloring method according to the ink jet printing technique has such a merit that the hand and feel of the resulting colored cloth are hardly damaged since a relatively thin color layer is uniformly formed on the cloth.

A variety of thickening agents can be used in the coloring composition of the present invention to adjust a viscosity of the composition to a desired level. Such a thickening agent usable herein may be, for instance, at least one member selected from the group consisting of synthetic polymers, celluloses and polysaccharides and terpene emulsions, which may be used alone or as a mixture comprising at least two of them.

Examples of such synthetic polymers usable herein are polyacrylic acids, polyvinyl alcohols, polyethylene oxides, polyvinyl pyrrolidone, polyvinyl methyl ethers, and poly(acrylamides). Examples of celluloses are ethyl cellulose, methyl cellulose, hydroxymethyl cellulose, and carboxymethyl cellulose. Examples of polysaccharides are xanthane gum, guar gum, casein, gum Arabic, gelatine, carrageenan, alginic acid, tragacanth gum, locust bean gum, and pectin. Examples of terpene emulsions usable herein are mousse-like emulsions prepared by emulsifying mineral terpene and water using a nonionic surfactant.

In the coloring composition of the present invention, water (for instance, tap water, distilled water, deionized (ion-exchanged) water, pure water and marine deep water) is used as a solvent. Alternatively, in addition to or other than water, aqueous solvents, which have polar groups and which are compatible with water, are preferably used in order to, for instance, impart water retention characteristics to the resulting liquid of the coloring composition and improve a stability of the pigment particles and polymer particles present therein. Examples of such aqueous solvents include methyl alcohol, ethyl alcohol, isopropyl alcohol, ethylene glycol, diethylene glycol, triethylene glycol, polyethylene glycol, propylene glycol, ethylene glycol monomethyl ether, glycerin and pyrrolidone. In addition to these aqueous solvents, usable herein also include, for instance, non-aqueous solvents such as liquid paraffins, mineral oils, and industrial gasolines insofar as they can be blended with and dispersed in water using, for instance, an emulsifying agent. These solvents may be used alone or as a mixture comprising at least two of them.

The content of water in the coloring composition of the present invention preferably ranges from 10 to 90% by mass and more preferably 30 to 80% by mass.

If the polymer particles are used alone in the coloring composition of the present invention, the resulting composition sometimes forms a film which is insufficient in film strength and fastness (durability) thereof. In this case, the durability of the film can be improved by the addition of a crosslinking agent which can undergo a crosslinking reaction with, for instance, hydroxyl groups and/or carboxyl groups present on or in the pigment and polymer particles.

The crosslinking reaction which may be used in the present invention includes, for instance, a dehydration-condensation reaction between methylol groups and hydroxyl groups; an epoxy ring-opening polymerization reaction between glycidyl groups and hydroxyl groups; a urethane reaction between isocyanate groups, and hydroxyl groups and/or carboxyl groups; an amide-ester reaction between oxazoline groups and carboxyl groups; an isourea reaction and a carbamoyl-amide reaction of carbodiimide groups with hydroxyl groups and carboxyl groups; a condensation-dehydration reaction of silanol groups with hydroxyl groups; a dehydration-condensation reaction of metal alkoxide groups with hydroxyl groups; a melamine-condensation reaction of multi-functional methylol groups with hydroxyl groups; and a reduction-dehydration reaction of diacetone-acrylamide with hydrazide and hydroxyl groups. If these water-soluble crosslinking agents are incorporated into the coloring composition and then heated, the hydroxyl groups and/or carboxyl groups present on the pigment and polymer particles cause a crosslinking reaction to form a three-dimensional network structure. Thus, the resulting color film layer has improved durability.

The content of the crosslinking agent in the coloring composition of the present invention preferably ranges from 0.1 to 5% by mass and more preferably 0.2 to 2.5% by mass.

In addition to the foregoing components, the coloring composition of the present invention may further comprise other additives (optional components), which are widely used in conventional coloring compositions, such as an antiseptic, an anti-fungal agent, a sequestering agent, a pH-adjusting agent, a lubricant, and/or a wetting agent, in an amount which does not adversely affect the intended effects of the present invention.

Examples of such antiseptic and anti-fungal agents usable herein include phenol, Sodium Omadine, sodium pentachlorophenol, 1,2-benz-isothiazolin-3-one, 2,3,5,6-tetrachloro-4-(methylsulfonyl) pyridine, and sodium benzoate; and alkali metal salts of benzoic acid, sorbic acid and dehydroacetic acid, and benzimidazole compounds.

Specific examples of the foregoing sequestering agents are benzotriazole, dicyclohexyl ammonium nitrite, diisopropyl ammonium nitrite, tolyl triazole, and saponins.

Examples of pH-adjusting agents include urea, aqueous ammonia, monoethanolamine, triethanolamine, aminomethyl propanol, alkali metal salts of phosphoric acid such as sodium tripolyphospate, and alkali metal hydroxides such as sodium hydroxide.

Specific examples of the foregoing wetting agents and lubricants include polyalkylene glycol derivatives such as polyoxyethylene lauryl ether, alkali metal salts of fatty acids, silicone oil emulsions, polyether-modified silicones such as polyoxyethylene glycol adducts of dimethylene polysiloxane, polytetrafluoroethylene powder, fluorine atom-containing surfactants, fluorine-modified oils and acetylene glycol.

Regarding the cloth colored with the coloring composition of the present invention according to the coloring method through printing, the pigment serving as a coloring agent is firmly adhered to the surface of the cloth by the action of the polymer which is contained in the composition and which is in the form of a film and accordingly, it is not necessary, after the coloration and drying, to use a step for removing, for instance, the excess coloring material, the sizing agent or paste, and the additives, through water-washing step, or the like. Moreover, in the coloring method which makes use of the coloring composition of the present invention, it is not needed to properly select different coloring materials for every fibrous materials and to adjust conditions for penetrate the coloring material into the cloth, such as heating temperature, pressure to be applied and stirring conditions. Accordingly, the coloring method of the present invention permits the coloration of mixed spun cloth simply using the coloring composition of the present invention according to the single-step coloring technique. Consequently, it could be said that the coloring method according to the present invention is an excellent method since it is excellent in working efficiency, energy efficiency and water resource-efficiency and it does not suffer from a problem of, for instance, any environmental pollution.

### EXAMPLES

Then the present invention will hereunder be described in more detail with reference to the following Pigment-Preparation Examples, Examples and Comparative Examples, but the present invention is not restricted to these specific Examples at all.

### Pigment-Preparation Example 1

### Pigment-Preparation Example Using Paint Shaker (Pigment 1)

| | | |
|---|---|---|
| Carbon black (PRINTEX #25) (*1) | 15.0 | parts by mass |
| Ethylene glycol | 5.0 | parts by mass |
| Styrene-maleic acid resin | 10.0 | parts by mass |
| (SMA-1000) (*2) | | |
| Acetylene glycol 104H (*3) | 0.2 | parts by mass |
| Water | 69.8 | parts by mass |

Each of the foregoing ingredients was dispensed in an amount specified above, followed by stirring in a dissolver to thus give a uniform mixture. The resulting blend was subjected to a stirring treatment in a paint shaker for 8 hours under such a condition that a filling rate by volume of beads was set at 60%. The average particle size of the resulting pigment particles prepared in this Pigment-Preparation Example 1 was determined using NICOMP 380ZLS (available from Nozaki Sangyo K.K.), according to the laser-diffraction technique which made use of polystyrene particles having a particle size of 100 nm (3100 A) and polystyrene particles having a particle size of 300 nm (3300 A) (both available from Duke Scientific Corporation) admitted by NIST (National Institute of Standards and Technology) and as a result, it was found to be 90 nm.

### Pigment-Preparation Example 2

A blend similar to that prepared in Pigment-Preparation Example 1 was treated in a paint shaker according to the same method used therein except for reducing the stirring time to 5 minutes. The average particle size of the resulting pigment particles prepared in this Pigment-Preparation Example 2 was determined by repeating the same procedures used in Pigment-Preparation Example 1 and as a result, it was found to be 250 nm.

### Stock Paste Formulation 1: (Thickening Agent 1)

| | |
|---|---|
| Water | 98.0 parts by mass |
| KELZAN (*4) | 2.0 parts by mass |

Each of the foregoing ingredients is dispensed in an amount specified above, followed by blending and stirring the resulting blend in a homomixer to thus give a thickening agent and this was used as a thickening agent in the following Examples and Comparative Examples.

### Stock Paste Formulation 2: (Thickening Agent 2)

| | | |
|---|---|---|
| Water | 37.0 | parts by mass |
| PEGASOL 3040 (*5) | 60.0 | parts by mass |
| Hi-ol PKC-500 (*6) | 1.0 | part by mass |
| Bismol ET-55 (*7) | 2.0 | parts by mass |

Each of the foregoing ingredients was dispensed in an amount specified above, followed by the emulsification of these ingredients in a homomixer to thus give a thickening agent in the form of a mousse and this was used as a thickening agent in the following Examples and Comparative Examples.

### Method for Preparing Coloring Compositions

Each of the ingredients specified in Tables 1 to 3 given below was dispensed in an amount likewise specified in the following Tables 1 to 3 and then the dispensed ingredients were stirred in a dissolver for about 2 hours to thus give each corresponding coloring composition.

### Method for Preparing White Composition for Surface-Coloration

When the surface of cloth was colored in a white color, the following coloring composition was used:

| | | |
|---|---|---|
| Water | 21.0 | parts by mass |
| TIPAQUE R550 (*8) | 3.0 | parts by mass |
| JONCRYL J-61J (*9) | 3.0 | parts by mass |
| Thickening Agent 1 | 15.0 | parts by mass |
| Thickening Agent 2 | 58.0 | parts by mass |

### Coloring Method

Cloth was colored with each of the coloring compositions prepared in the foregoing Examples and Comparative Examples, using a silk-screen printing plate having 230 mesh size.

### Test for Confirming Brightness of Color

Each cloth subjected to the foregoing coloring treatment was inspected for brightness of color on the back (colored surface) of the cloth using a spectroscopic colorimeter: MSC-IS-2B (available from SUGA TEST INSTRUMENTS CO., LTD.). The brightness of color is herein expressed in terms of L* value in the L*a*b* Color Specification and the light source used was D65-2°.

### Test for Confirmation of See-Through-Prevention

Each cloth subjected to the foregoing coloring treatment was inspected for the ability of preventing see-through according to the following procedures and it was evaluated on the basis of the criteria specified later.

1) A test piece pigmented with a predetermined color was adhered to the back side of cloth and the reflectance observed on the right side of the cloth was determined.

2) A white test piece was adhered to the back side of cloth in the same manner and the reflectance observed on the right side of the cloth was likewise determined.

3) Then the difference between the reflectance values observed for the light rays having a predetermined wavelength (the difference obtained by subtracting the reflectance obtained in the foregoing item 1 from that obtained in the foregoing item 2) was determined or calculated.

In this connection, the smaller the difference calculated above, the higher the see-through-preventing effect of the specimen. At this stage, the test for the determination of the reflectance was carried out using a device: UVPC-2400PC (available from Shimadzu Corporation).

### Color-See-Through Phenomenon on Right Side

Each cloth subjected to the foregoing coloring treatment was inspected for the surface brightness of color using a spectroscopic colorimeter: MSC-IS-2B (available from SUGA TEST INSTRUMENTS CO., LTD.).

### Test for Confirming Hand and Feel

Each cloth subjected to the foregoing coloring treatment was compared with the original cloth prior to the coloration and the change in hand and feel thereof were examined by touching with fingers and evaluated on the basis of the following criteria:

◯: There was not observed any change at all;

Δ: There was observed slightly hard hand and feel;

x: There was observed distinct change in hand and feel.

### Test for Fastness to Rubbing

Fastness to rubbing of each cloth subjected to the foregoing coloring treatment was determined and evaluated according to the testing method and evaluation criteria specified in JIS L 0849. The evaluation of dry or wet fastness to rubbing was judged while adopting the criteria as specified in JIS L 0801-9 (determination of dyeing fastness). More specifically, fastness to rubbing was determined according to the following procedures:

A test piece (cotton, twill) and a piece of white cotton cloth for rubbing (cotton, shirting or calico) were rubbed with one another using an abrasion machine: FR-2 Model (available from SUGA TEST INSTRUMENTS CO., LTD.) and according to the prescribed method and the degree of the coloration of the piece of white cotton cloth for rubbing was compared with the gray scale for the evaluation of contamination or staining to thus judge the extent of fastness to rubbing of each cloth.

JIS L 0801: General Rules of Method for Testing Color Fastness

JIS L 0803: Attached White Cloth for Color Fastness Test

JIS L 0805: Gray Scale for Evaluating Contamination or Staining.

The results thus obtained are summarized in the following Tables 1 to 6:

TABLE 1
Coloring Composition: Illustrative Blend 1

| Blend Ex. No. | 1 | 2 | 3 | 4 | 5 | 6 |
|---|---|---|---|---|---|---|
| Pig-Pre-Ex. 1¹⁾ | | | | | 1 | |
| Pig-Pre-Ex. 2 | | | | | | 1 |
| Pig-Pre-Ex. 1 | 8 | 16 | 4 | 2 | | |
| 100 times | | | | | | |
| diluted | | | | | | |
| U-205 *10 | (3) | (3) | (3) | (3) | (3) | (3) |
| SF-700 *11 | | | | | | |
| SF-110 *12 | | | | | | |
| J-7100 *13 | | | | | | |
| J-840 *14 | | | | | | |
| J-734 *15 | | | | | | |
| J-780 *16 | | | | | | |
| Thickener 2 | 58 | 58 | 58 | 58 | 58 | 58 |
| Thickener 1 | 15 | 15 | 15 | 15 | 15 | 15 |
| Water | Balance | Balance | Balance | Balance | Balance | Balance |

¹⁾The product prepared in Pigment-Preparation Example 1.
Note 1:
Each numerical value given in the parentheses means the amount of the solid content of each corresponding ingredient to be incorporated into the coloring composition.
Note 2:
Pig-Pre-Ex. 1 100 times diluted was Pig-Pre-Ex. 1 diluted with water in a ratio of 1:99 (Pig-Pre-Ex. 1:water).

TABLE 2
Coloring Composition: Illustrative Blend 2

| Blend Ex. No. | 7 | 8 | 9 | 10 | 11 | 12 |
|---|---|---|---|---|---|---|
| Pig-Pre-Ex. 1¹⁾ | 1 | 1 | 1 | 1 | 1 | 1 |
| U-205 *10 | | | | | | |
| SF-700 *11 | (3) | | | | | |
| SF-110 *12 | | (3) | | | | |
| J-7100 *13 | | | (3) | | | |
| J-840 *14 | | | | (3) | | |
| J-734 *15 | | | | | (3) | |
| J-780 *16 | | | | | | (3) |
| Thickener 2 | 58 | 58 | 58 | 58 | 58 | 58 |
| Thickener 1 | 15 | 15 | 15 | 15 | 15 | 15 |
| Water | Balance | Balance | Balance | Balance | Balance | Balance |

¹⁾The product prepared in Pigment-Preparation Example 1.
Note 1:
Each numerical value given in the parentheses means the amount of the solid content of each corresponding ingredient to be incorporated into the coloring composition.

TABLE 3
Coloring Composition: Comparative Illustrative Blends

| Comparative Blend Ex. No. | 1 | 2 | 3 | 4 |
|---|---|---|---|---|
| Pig-Pre-Ex. 1¹⁾ | | 16 | | |
| Pig-Pre-Ex. 1 100 times | 1 | | | 4 |
| diluted. | | | | |
| U-205 *10 | (3) | (3) | (3) | |
| SF-700 *11 | | | | |
| SF-110 *12 | | | | |
| J-7100 *13 | | | | |
| J-840 *14 | | | | |
| J-734 *15 | | | | |
| J-780 *16 | | | | |
| J-61J *9 | | | | (3) |
| Thickener 2 | 58 | 58 | 58 | 58 |
| Thickener 1 | 15 | 15 | 15 | 15 |
| Water | Balance | Balance | Balance | Balance |

¹⁾The product prepared in Pigment-Preparation Example 1.
Note 1:
Each numerical value given in the parentheses means the amount of the solid content of each corresponding ingredient to be incorporated into the coloring composition.
Note 2:
Pig-Pre-Ex. 1 100 times diluted was Pig-Pre-Ex. 1 diluted with water in a ratio of 1:99 (Pig-Pre-Ex. 1:water).

TABLE 4
Cloth-Coloration Test Example 1

| Example No. | 1 | 2 | 3 | 4 | 5 | 6 |
|---|---|---|---|---|---|---|
| Coloring Composition: | 1 | 2 | 3 | 4 | 7 | 3 |
| Blend Ex. No. | | | | | | |

Brightness of Color

| | | | | | | |
|---|---|---|---|---|---|---|
| Surface (Right Side) | 91.8 | 90 | 93.8 | 95.5 | 86.2 | 97 |
| Back | 78.2 | 66.7 | 86.3 | 90.8 | 48.1 | 86.1 |

Difference in Reflectance

| | | | | | | |
|---|---|---|---|---|---|---|
| Yellow | 1.4 | 0.3 | 4.2 | 6.8 | 0.1 | 3.3 |
| Pink | 2 | 0.8 | 5 | 7.8 | 0.6 | 4 |
| Light Blue | 1.3 | 0.8 | 5 | 7.8 | 0.5 | 3.9 |
| Black | 2.4 | 1 | 5.8 | 8.8 | 0.2 | 4.6 |
| Hand and Feel | ◯ | ◯ | ◯ | ◯ | ◯ | ◯ |

Wavelengths of Reflected Light Rays Determined:
Yellow: 490 nm;
Pink: 550 nm;
Light Blue: 550 nm;
Black: 550 nm.

TABLE 5
Cloth-Coloration Test Example 2

| Example No. | 7 | 8 | 9 | 10 |
|---|---|---|---|---|
| Coloring Composition: Blend Ex. No. | 5 | 7 | 8 | 9 |

Brightness of Color

| | | | | |
|---|---|---|---|---|
| Surface (Right Side) | 86.1 | 86.2 | 85.9 | 85.6 |
| Back | 46.9 | 48.1 | 47.7 | 48.6 |

Fastness to Rubbing (Contamination or Staining)

| Dry | 3 | 3 | 2-3 | 4 |
|---|---|---|---|---|
| Wet | 3 | 3 | 2-3 | 3-4 |
| Hand and Feel | ◯ | ◯ | ◯ | ◯ |
| Example No. | 11 | 12 | 13 | 14 |
| Coloring Composition: Blend Ex. No. | 10 | 11 | 12 | 6 |

Brightness of Color

| | | | | |
|---|---|---|---|---|
| Surface (Right Side) | 86.6 | 86 | 85.9 | 86.7 |
| Back | 48.5 | 48.1 | 47.9 | 48.8 |

Fastness to Rubbing (Contamination or Staining)

| | | | | |
|---|---|---|---|---|
| Dry | 3 | 2-3 | 2-3 | 2-3 |
| Wet | 3 | 2-3 | 2-3 | 2-3 |
| Hand and Feel | ◯ | ◯ | ◯ | ◯ |

TABLE 6
Cloth-Coloration Comparative Test Examples

| Comparative Example No. | 1 | 2 | 3 | 4 |
|---|---|---|---|---|
| Coloring Composition: Comp. Blend Ex. No. | 1 | 2 | 3 | 4 |

Brightness of Color

| | | | | |
|---|---|---|---|---|
| Surface (Right Side) | 96.3 | 83.1 | 97.1 | 94.2 |
| Back | 95.8 | 32.9 | 96.9 | 86.7 |

Difference in Reflectance

| | | | | |
|---|---|---|---|---|
| Yellow | 10.8 | 0.2 | 11.9 | 4.1 |
| Pink | 12.1 | 0.8 | 12.8 | 5.2 |
| Light Blue | 12.9 | 0.9 | 13.3 | 4.9 |
| Black | 14.8 | 0.1 | 15.4 | 5.3 |

Fastness to Rubbing (Contamination or Staining)

| | | | | |
|---|---|---|---|---|
| Dry | 4-5 | 3 | 5 | 2 |
| Wet | 4-5 | 1-2 | 5 | 1 |
| Hand and Feel | ◯ | ◯ | ◯ | X |

The materials (*1) to (*16) used in the foregoing Examples are as follows:
*1: Printex #25 (a black pigment available from Degussa Japan Co., Ltd.);
*2: SMA-1000 (a dispersant resin available from Arakawa Chemical Industry Co., Ltd.);
*3: Acetylene Glycol 104H (a wetting agent available from Nisshin Chemical Industry Co., Ltd.);
*4: KELZAN (Xanthane gum available from Sansho Co., Ltd.);
*5: Vegazol 3040 (Mineral spirit manufactured by EXXON MOBIL Corporation);
*6: Hi-ol PKC-500 (an emulsifying agent manufactured by Hayashi Chemical Industry Co., Ltd.);
*7: Bismol ET-55 (an emulsifying thickener manufactured by Toho Chemical Industry Co., Ltd.);
*8: TIPAQUE R550 (Titanium oxide manufactured by Ishihara Sangyo Kaisha, Ltd.);
*9: JONCRYL J-61J (a water-soluble acrylic resin manufactured by Johnson Polymer Company);
*10: U-205 (A urethane particle dispersion manufactured by Alberding Company; Tg<10° C.);
*11: SF-700 (A urethane particle dispersion manufactured by Dai-ichi Kogyo Seiyaku Co., Ltd.; Tg: 6° C.);
*12: SF-110 (A urethane particle dispersion manufactured by D aiichi Kogyo
*13: JONCRYL 7100 (A styrene-acrylic resin particle dispersion manufactured by Johnson Polymer Company; Tg: −10° C.);
*14: JONCRYL 840 (A styrene-acrylic resin particle dispersion manufactured by Johnson Polymer Company; Tg: 16° C.);
*15: JONCRYL 734 (A styrene-acrylic resin particle dispersion manufactured by Johnson Polymer Company; Tg: 30° C.);
*16: JONCRYL 780 (A styrene-acrylic resin particle dispersion manufactured by Johnson Polymer Company; Tg: 92° C).

Examples of the coloring compositions according to the present invention are summarized in Tables 1 and 2; Examples of the coloring compositions according to the Comparative Examples are summarized in Table 3; Examples of cloth-coloration according to the present invention are summarized in Tables 4 and 5; and Examples of cloth-coloration according to the Comparative Examples are summarized in Table 6.

As will be seen from the data listed in Table 4, the pieces of cloth obtained in Examples 1 to 6 of the present invention show a small difference in the reflectance even if the brightness of color on the back of the cloth is high or even if the cloth is not deeply colored. In other words, the cloth treated according to the present invention has a high see-through-preventing effect. In addition, it is also clear that any color-see-through phenomenon can certainly be inhibited because of the high brightness of color on the right side of the cloth. In the meantime, Example 6 relates to a piece of cloth whose surface is colored with the aforementioned white coloring composition for surface-coloration. The brightness of color of the cloth of Example 6 is improved when comparing with the result obtained in Example 3 and this clearly indicates that the whiteness of the cloth treated in Example 6 is increased. Furthermore, the value of the difference in the reflectance is reduced and accordingly, the cloth of Example 6 is improved in the see-through-preventing effect.

The pieces of cloth are slightly deeply colored in Examples 7 to 14 for the purpose of confirming fastness to rubbing, but it is clear that the cloth has a sufficiently high fastness to rubbing. Moreover, these results suggest that fastness to rubbing is dependent upon the glass transition temperature of the polymer particles used. It is recognized that the fastness to rubbing observed in Example 14 is slightly lower than that observed in Example 7 since pigment particles having a relatively large particle size are used in Example 14.

Comparative Examples 1 and 3 are examples in which the brightness of color on the back of the cloth is beyond the upper limit specified in the present invention and the results obtained in these Comparative Examples indicate that the difference in the reflectance is large and the see-through-preventing effect is correspondingly insufficient.

Comparative Example 2 is an example in which the brightness of color on the back of the cloth is less than the lower limit specified in the present invention and the results obtained in this Comparative Example indicate that the see-through-preventing effect is high, but the brightness of color of the surface is low and the cloth causes color-see-through phenomenon.

Comparative Example 4 is an example in which a water-soluble polymer resin is substituted for the polymer particulate dispersion. The results obtained in this Comparative Example indicate that the resulting colored cloth is insufficient in the fastness to rubbing.

1. A coloring composition for preventing see-through of cloth characterized in that it comprises, on the basis of the total mass of the composition, the following components:
a pigment in an amount ranging from 0.002% by mass to 1% by mass;
a polymer particulate dispersion; and
water.

2. The coloring composition for preventing see-through of cloth as set forth in claim 1, wherein the polymer particulate dispersion comprises at least one component selected from the group consisting of polyurethanes, polyesters and polyacrylics.

3. The coloring composition for preventing see-through of cloth as set forth in claim 1, wherein the polymer particulate dispersion has a glass transition temperature of not higher than 20° C.

4. The coloring composition for preventing see-through of cloth as set forth in claim 1, wherein the average particle size of the pigment is not greater than 150 nm.

5. The coloring composition for preventing see-through of cloth as set forth in claim 1, wherein the pigment is a black pigment.

6. A method of coloring the back of cloth characterized by the use of a coloring composition for preventing see-through of the cloth as set forth in claim 1.

7. Cloth characterized in that the back of the cloth is colored with at least a pigment and a polymer particulate dispersion and that the brightness of color of the cloth thus colored ranges from 40 to 93 (L*: D65-2°).

8. The cloth as set forth in claim 7, wherein the polymer particulate dispersion comprises at least one component selected from the group consisting of polyurethanes, polyesters and polyacrylics.

9. The cloth as set forth in claim 7, wherein the polymer particulate dispersion has a glass transition temperature of not higher than 20° C.

10. The cloth as set forth in claim 7, wherein the average particle size of the pigment is not greater than 150 nm.

11. The cloth as set forth in claim 7, wherein the pigment is a black pigment.

12. The cloth as set forth in claim 7, wherein the right side of the cloth is white or colored with a light or pale color.

13. Clothes characterized in that they are obtained using cloth as set forth in claim 7.
